(19) United States
(12) Patent Application Publication
(10) Pub. No.: US 2008/0284574 A1
(43) Pub. Date: Nov. 20, 2008

(54) Device for Determining the Roll Angle and System and Method for Roll Stabilization of a Motor Vehicle

(75) Inventor: Peter Bosch, Esslingen (DE)

Correspondence Address: FITCH, EVEN, TABIN & FLANNERY, P. O. BOX 18415, WASHINGTON, DC, 20036, US

(73) Assignee: Daimler AG, Stuttgart (DE)

(21) Appl. No.: 11/547,267

(22) PCT Filed: Mar. 30, 2005
(86) PCT No.: PCT/EP2005/003299

§ 371 Date: Nov. 7, 2006

(30) Foreign Application Priority Data
Apr. 10, 2004 (DE) 102004017634.5

(51) Int. Cl. B60G 17/015; B60Q 1/00

(52) U.S. Cl. 340/438; 701/41; 701/36

(57) ABSTRACT

The present invention relates to a device for determining the roll angle and a system and a method for roll stabilization of a motor vehicle with a yaw rate sensor arrangement (1) of an existing driving dynamics control system which, for detecting a combined signal consisting of yaw rate and roll rate, is with its measuring axis inclined at a predetermined inclination angle (α) in relation to the vertical axis in the plane passing through the longitudinal axis and the vertical axis of the motor vehicle; and with at least one observer (3), preferably designed as a Kalman filter, which, for determining the roll angle (φ), splits the combined signal detected by the yaw rate sensor arrangement (1) into the two signal components yaw rate and roll rate. Furthermore, the roll angle (φ) determined is compared with a predetermined threshold value by means of an analyzer arrangement (2, 130), and an appropriate stabilization measure is activated by means of an activation arrangement (130) in the event of the predetermined threshold value being exceeded by the roll angle (φ) determined.

The present invention relates to a device for determining the roll angle of a motor vehicle and a system and a method for roll stabilization of a motor vehicle, in particular of buses, transporters, trucks or the like.

Active and passive safety systems in the motor vehicle field play an ever greater role in the continuing development of vehicles. The expectations of customers require both performance and comfort, focused on increasing safety for the vehicle occupants.

In addition to the passive and active safety systems, such as airbag, crash protection and seat-belt tensioners, active driving safety is constantly gaining in importance with its ever increasing possibilities. In this connection, the aim of the development is a control system which detects the instantaneous driving situation rapidly and can immediately intervene actively in any critical situation or provide the driver with a corresponding signal for manually changing the driving situation. In this connection, the first steps of an active vehicle control have already been made with ABS, ASR or the electronic stability program ESP.

For example, straight driving of motor vehicles, in particular in the case of high driving speeds or motor vehicles with a large vertical extent, is influenced by side wind or by surface unevenness. Consequently, in particular in vehicles in which there is a great distance between the point of application of the resulting wind force and the vehicle center of gravity or a great distance between the vehicle center of gravity and the wheel footprint, for example in the case of buses, transporters, cross-country vehicles or the like, a torque about the roll axis of the vehicle extending in the longitudinal direction is brought about under the effect of side wind or surface unevenness. Lateral rotation of the center of gravity leads at least to an unstable driving state and, in the event of the center of gravity of the vehicle being rotated out beyond the tire/road point of support, may even result in tipping or rolling of the motor vehicle.

It has already been known for a long time that, in vehicles with a high center of gravity and/or a small track, for example trucks, truck-trailers, buses, minibuses and cross-country vehicles, there is a risk of tipping during cornering with a great rolling motion. However, it has recently been found that passenger cars can also become unstable laterally to the point of tipping over. Such a tipping risk is increased considerably by inappropriate loading, for example extremely one-sided loading or loading on the vehicle roof, because the position of the center of gravity of the vehicle is shifted upward or toward one side. Nowadays, moreover, increasing numbers of vehicles which are designed as passenger cars with a relatively high center of gravity are being licensed, for example the new vehicle class of vans or sport utility vehicles.

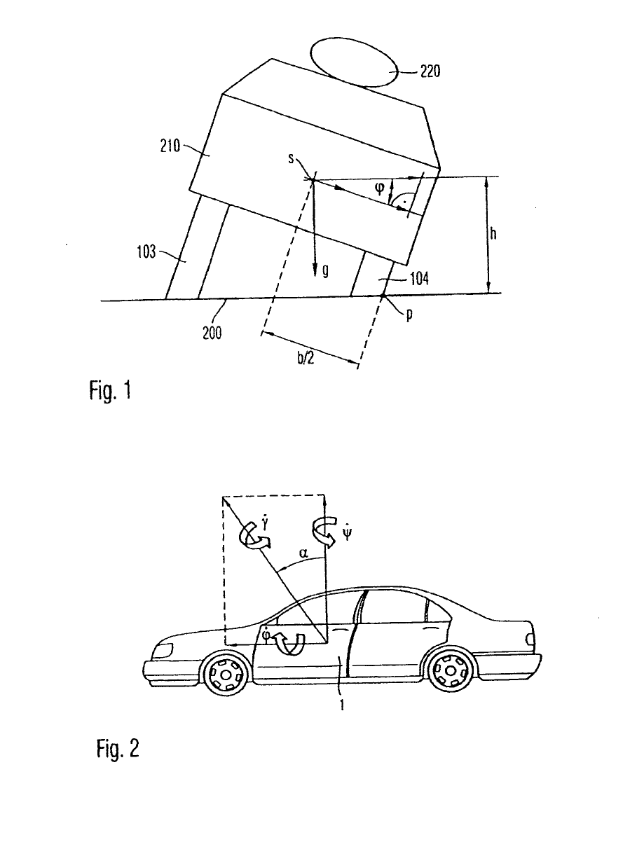

To explain the underlying driving physics during tipping, FIG. 1 shows a diagrammatic rear view of a vehicle 210 standing on a roadway 200. 103 and 104 accordingly designate the wheels on the rear axle. It is assumed that the vehicle 210 is driving through a left bend and would consequently, in a projection onto the drawing plane, move toward the left. A centrifugal force arises owing to the circular travel of the vehicle. The active centrifugal force can be regarded as acting on the center of gravity S of the vehicle. The center of gravity S lies approximately centrally between the wheels and at a height h above the roadway. The weight g acts on the center of gravity. As long as the vehicle drives on the desired circle, that is as long as the lateral forces on the four wheels are the same as the centrifugal force, said centrifugal forces will arise. It may then happen that, owing to an unfavorable moment distribution, the vehicle tips via the outer wheel. If the outwardly rotating moment is greater than the inwardly rotating moment, the vehicle tips outward. This risk arises in particular in vehicles with a small track and a comparatively great height and thus a high center of gravity S, and is also caused by a roof load 220 on the vehicle 210, for example.

In order for it to be possible effectively to avoid such an operating state, a critical situation, in particular a driving state with a critical roll angle, which is designated by p in FIG. 1, must be detected, and appropriate countermeasures must be taken on account of the detection.

In principle, various intervention strategies exist in the prior art. For example, the transverse acceleration can be limited by a fixed transverse acceleration limit, or a variable limit of the transverse acceleration can be provided as a function of the center of gravity height, the center of gravity position and/or the overall mass of the motor vehicle. Limitation of the roll angle can be provided as another approach. The simplest option would be limitation of the transverse acceleration with a firmly defined limit.

However, the fact that the limitation of the transverse acceleration has to be geared to the most critical loading and situation, which results in the system intervening too soon in most situations and restricting the driver considerably in his driving dynamics, has proved to be a disadvantage of this approach. Broadening it by varying the transverse acceleration limit as a function of the center of gravity height and if appropriate the overall mass of the motor vehicle requires an observer which can estimate or measure these values. However, the prior art contains only very rough estimation methods for overall mass. Furthermore, the center of gravity height cannot be measured or observed reliably.

Known methods according to the prior art can include reliable measurement and observation of the roll angle. Such systems have at least one additional roll rate sensor, which has to be additionally installed in an existing system and matched and connected to certain components. This requires great additional expenditure of work and additional production costs.

It is consequently an object of the present invention to provide a device or a system and a method with which the roll angle of a motor vehicle can be determined while avoiding the abovementioned disadvantages and appropriate stabilization measures can be initiated.

According to the invention, this object is achieved by the device with the features of claim 1, the system with the features of claim 4 and, as far as the method is concerned, by the method with the features of claim 9.

The underlying idea of the present invention consists in that the yaw rate sensor arrangement of an existing driving dynamics control system is, for detecting a combined signal consisting of yaw rate and roll rate, installed in the motor vehicle with its measuring axis inclined at a predetermined inclination angle in relation to the vertical axis in the plane passing through the longitudinal axis and the vertical axis of the motor vehicle. The combined signal thus determined is, for determining the roll angle of the motor vehicle, split into the two signal components yaw rate and roll rate by means of at least one observer, which is preferably designed as a Kalman filter. Furthermore, the method according to the invention makes provision that this determined roll angle is compared with a predetermined threshold value by means of an analyzer arrangement and, if appropriate, an appropriate stabilization measure is activated by means of an activation arrangement in the event of a threshold value being exceeded by the roll angle determined. In this connection, the activation arrangement is connected to the analyzer arrangement for evaluating the data received or is a component thereof. The driving dynamics control system mentioned above is a system with which the yaw rate of the vehicle, that is the rotary motion of the vehicle about its vertical axis, is controlled by individual-wheel brake actions. Such a driving dynamics control system is used in vehicles of the applicant under the name ESP system, for example.

The present invention consequently has the advantage in relation to the prior art that the roll angle can be determined and evaluated simply on the basis of the driving dynamics sensor technology already present in the motor vehicle on account of the driving dynamics control system. The basis for this is the special inclined installation of the yaw rate sensor of the driving dynamics sensor technology. The roll angle can consequently be determined without additional sensor technology, as a result of which additional production costs, additional assembly costs and additional assembly effort can be avoided. Furthermore, in contrast to transverse acceleration limitation, roll angle limitation is loading-independent. The driving dynamics sensor technology mentioned above usually comprises at least wheel sensors assigned to the vehicle wheels, a steering wheel angle sensor, a transverse acceleration sensor and the yaw rate sensor already mentioned.

The dependent claims contain advantageous developments and improvements of the device indicated in claim 1, the system indicated in claim 4 and the method indicated in claim 9.

According to a preferred development, the yaw rate sensor arrangement is preferably inclined by a predetermined inclination angle of approximately 30° in relation to the vertical axis in the plane passing through the longitudinal axis and the vertical axis of the motor vehicle. The inclination is preferably effected in the direction of the motor vehicle front side. The yaw rate sensor arrangement is preferably arranged in the center of gravity of the motor vehicle. However, other installation locations and inclination angles are likewise possible.

In particular in a case where the vehicle is equipped with a sensor module which contains both a yaw rate sensor and a transverse acceleration sensor, installation of this sensor module in proximity to the center of gravity of the vehicle is necessary. The reason for this special installation location is that the signal generated by a transverse acceleration sensor depends to a great extent on the installation location of the transverse acceleration sensor. Only if the transverse acceleration sensor is installed in proximity to the center of gravity of the vehicle does the signal generated by it represent the transverse acceleration acting on the vehicle without a transformation being necessary for this signal. In the case of a sensor module, the yaw rate sensor is consequently also installed in proximity to the center of gravity of the vehicle. The situation is different if, instead of the sensor module described above, an independent yaw rate sensor and transverse acceleration sensor are installed in the vehicle. In this case, the yaw rate sensor does not necessarily have to be installed in proximity to the center of gravity of the vehicle. The reason for this is that the vehicle constitutes a rigid body, and each point of the vehicle therefore rotates at the same rate.

According to a further preferred illustrative embodiment, the brake system of the motor vehicle can be acted on by the existing driving dynamics control system as a stability measure on the basis of the roll angle determined. Furthermore, alternatively or additionally, a warning signal can be issued to the driver, who can initiate corresponding braking activities.

The state variables, for example the steering wheel angle, the transverse acceleration, the wheel speeds, the yaw rate or the like, determined by the existing driving dynamics control system are preferably also taken into consideration and also evaluated in the determination of the kinematic state of the motor vehicle.

A storage arrangement is provided, for example, in which the threshold values are stored.

The connection between an observer and a Kalman filter is to be described here. In general terms, a Kalman filter is a special form of an observer. An observer can consequently be designed either as a simple observer or as a Kalman filter.

A Kalman filter contains what is known as a reference model, which is permanently compared with the measured state variables, that is with the measured variables. The overall state of motion of the vehicle can thus be observed relatively reliably in general. In other words, variables which describe the state or the motion of the vehicle can be determined with a Kalman filter, which, as already mentioned, is based on a reference model or state model.

The splitting of the combined signal detected by the yaw rate sensor arrangement into the two signal components yaw rate and roll rate can in any case take place with the aid of a Kalman filter. However, a simple observer, that is an observer which is not designed as a Kalman filter, is also capable of splitting the signal measured with the inclined sensor into the yaw rate and the roll rate by means of a suitable algorithm. The physical facts forming the basis of the splitting are to be explained with reference to part-FIGS. 4a, 4b and 4c.

Part-FIGS. 4a, 4b and 4c illustrate the time profiles of the state variables roll angle, yaw rate and transverse acceleration which arise when a steering angle jump takes place in a vehicle travelling at a speed of 100 km/h. As can be seen from part-FIGS. 4a, 4b and 4c, the roll angle, the yaw rate and the transverse acceleration increase roughly linearly when a steering angle jump takes place until they reach their stationary value approximately simultaneously. The roll rate, which is the temporal derivative of the roll angle, accordingly has an approximately constant value during the increase in the yaw rate, while the roll rate assumes approximately the value zero in the stationary phase of the yaw rate.

It can therefore be assumed that the signal measured by the yaw rate sensor arrangement installed in an inclined position corresponds to a sum of two differently weighted signals, one signal corresponding approximately to the derivative of the other signal. The signals roll rate and yaw rate can thus be separated mathematically in a first approximation. The weighting of the signals is based on weighting parameters which are dependent on the inclination angle of the yaw rate sensor arrangement and thus constant. The signals are further refined and corrected by different filtering operations and comparisons with state variables derived from other measured variables; these measured variables may be the wheel speeds, the steering wheel angle and/or the transverse acceleration, for example. This splitting is made possible by the temporal behavior of the two variables roll rate and yaw rate, which is different in principle. All the measured variables, that is the wheel speeds, the transverse acceleration, the steering wheel angle and the signal of the inclined yaw rate sensor arrangement, must be plausible in relation to one another and consequently together produce a conclusive picture of the state of motion of the whole vehicle. Firstly, separation into the two signals roll rate and yaw rate can thus take place, and, on the other hand, the plausibility can also be checked.

With regard to the plausibility check described above, the following is pointed out with reference to FIGS. 4a, 4b and 4c: the transverse acceleration and the yaw rate display a temporal behavior which is essentially alike, for example, whereas a comparison of the roll angle with the transverse acceleration suggests the conclusion that the roll rate essentially has a time profile as is to be expected for the temporal derivative of the transverse acceleration.

According to the statements above, the steering wheel angle, the transverse acceleration, the wheel speeds and the signal generated by the yaw rate sensor arrangement, which contains the roll rate and the yaw rate, are consequently supplied to the observer or the Kalman filter as input variables.

Alternatively, the observer can also be embodied as a PT1 and/or PT2 filter, or as a high pass and/or low pass. The filter is advantageously realized as a combination of a number of individual filters. In this case, splitting into roll rate and yaw rate is performed by switching over between the individual filters.

It should also be stated at this point that the consideration above of the particular driving situation is not intended to have any limiting effect. The splitting of the signal detected with the yaw rate sensor arrangement into the two components roll rate and yaw rate is possible for any driving situation of the vehicle.

Illustrative embodiments of the present invention are explained in greater detail below with reference to the accompanying figures of the drawings, in which

FIG. 1 shows a diagrammatic rear view of a motor vehicle in a left bend;

FIG. 2 shows a side view of a motor vehicle with a yaw rate sensor installed in an inclined position;

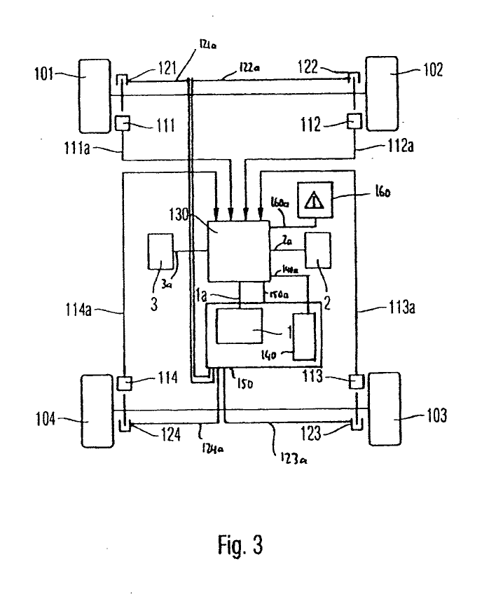

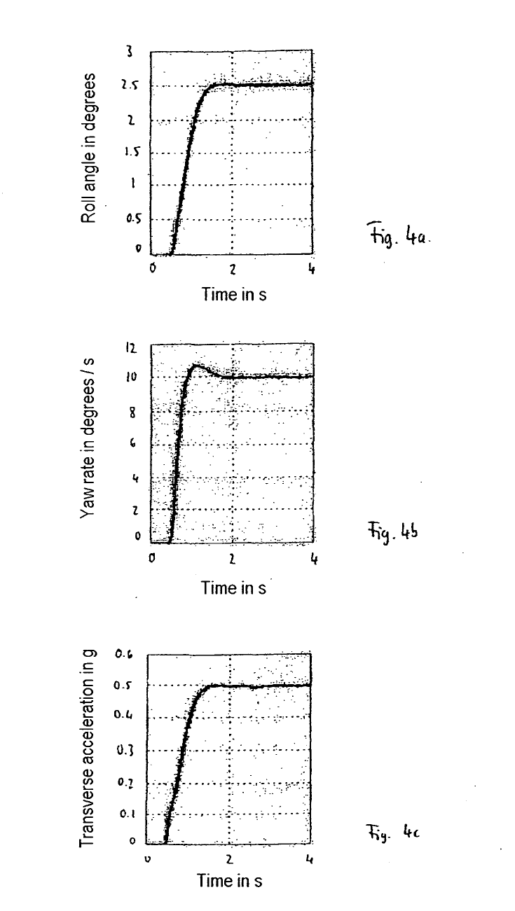

FIG. 3 shows a diagrammatic illustration of a system according to the invention according to an illustrative embodiment of the present invention, and

FIG. 4 made up of part-FIGS. 4a, 4b and 4c, shows the time profiles of the variables roll angle, yaw rate and transverse acceleration in a given driving situation of the vehicle.

In the figures, unless otherwise indicated, identical reference signs designate the same or functionally equivalent components.

FIG. 2 illustrates a side view of a motor vehicle with a yaw rate sensor 1 installed in an inclined position according to an illustrative embodiment of the present invention. As can be seen in FIG. 2, the yaw rate sensor 1 is installed in the motor vehicle inclined in the direction of the motor vehicle front side by an inclination angle a in relation to the vertical axis-of the motor vehicle in the plane passing through the vertical axis and the longitudinal axis of the motor vehicle. In this connection, the yaw rate sensor 1 is preferably the yaw rate sensor 1 provided in a driving dynamics control system already present in a motor vehicle. In contrast to the usual mode of installation, however, installation takes place, as already explained above, at the predetermined inclination angle α. In this connection, the inclination angle can be 30°, for example. It is obvious for an expert that other inclination angles are also possible. It is crucial only that a combined signal consisting of yaw rate and roll rate is determined by a common yaw rate sensor 1 by virtue of inclination of the yaw rate sensor 1. In this connection, the signal received by the yaw rate sensor 1 can be represented by the following equation, for example:

\dot{γ}=\dot{ψ}· cos α+\dot{φ}· sin α

where a designates the inclination angle of the yaw rate sensor 1, \dot{γ} the rotating rate determined, \dot{ψ} the yaw rate measured and \dot{φ} the roll rate measured. In this connection, rotary motions about the longitudinal axis of the motor vehicle are described as rolling, designated by the roll angle φ as a state variable, and rotations about the vertical axis of the motor vehicle are described as yawing, designated by the yaw angle ψ as a state variable.

Owing to the inclined installation, the yaw rate sensor arrangement 1 of the existing driving dynamics control system detects a combined signal consisting of yaw rate and roll rate. The signal representing the roll rate and the signal representing the yaw rate can be separated from one another as they are temporally isolated from one another. A roll rate is, for example, present only when turning into a bend, and the associated signal is considerably more clearly pronounced at the start of turning into the bend than the yaw rate. When the roll rate stabilizes, that is with a roll rate equal to zero, which represents constant cornering, it is mainly the yaw rate during cornering which is represented by the signal. Temporal separation of the signals representing the roll rate from the signals representing the yaw rate is consequently possible. These facts can also be inferred from part-FIGS. 4a, 4b and 4c.

Consequently, at the expense of a weakening of the yaw rate signal, the inclined installation of the yaw rate sensor 1 ensures that, in addition to a weakened yaw rate signal, a roll rate signal which is isolated from the yaw rate signal can also be detected by means of the yaw rate sensor 1 already present in the driving dynamics control system.

FIG. 3 shows a diagrammatic illustration of a system according to the invention according to a preferred illustrative embodiment of the present invention.

In the diagrammatic top view of a motor vehicle illustrated in FIG. 3, 101 and 102 designate the front wheels and 103 and 104 the rear wheels of the motor vehicle. According to the prior art, this motor vehicle has front wheel brakes and rear wheel brakes 121 to 124, and also the wheel sensors 111 to 114 known in an anti-locking system (ABS) or an electronic stability program (ESP), by means of which the rotational speeds or the wheel speeds of individual wheels can be determined. In this connection, what are known as corrected wheel speeds are in general taken as a basis, in which wheel-specific data such as wheel diameter is taken into consideration. The data obtained by the wheel sensors 111 to 114 is forwarded by means of respective associated signal lines 111a to 114a.

The system also has a yaw rate sensor 1, which is arranged in an inclined position in the motor vehicle in the way mentioned above. For detailed information with regard to the yaw rate sensor 1, reference is made to the statements above.

The yaw rate sensor 1 is connected to a control apparatus 130 by means of a signal line 1a and conducts the combined signal determined, consisting of roll rate and yaw rate, to the control apparatus 130. The control apparatus 130 is also connected via the signal lines 111a to 114a to the corresponding wheel sensors 111 to 114 of, for example, a driving dynamics control system 150 present in the motor vehicle. This driving dynamics control system comprises the following components, which will in some cases be described in greater detail below: a brake system, consisting of the wheel brakes 121, 122, 123, 124 and correspondingly associated operating components, which are either part of the activation arrangement 130 or of the driving dynamics control system 150, wheel sensors 111, 112, 113, 114, a yaw rate sensor 101, and further sensors belonging to the driving dynamics control system, namely a steering wheel angle sensor and a transverse acceleration sensor, which are combined into a block 140 in FIG. 3.

Furthermore, a storage arrangement 2, which is connected via a signal line 2a to the control apparatus 130 and in which predetermined threshold values can be stored, is preferably provided in the system.

Additionally, an observer 3 designed as a Kalman filter, which splits the combined signal of the yaw rate sensor 1 into the components yaw rate and roll rate, is preferably connected to the control apparatus 130 via a corresponding signal line 3a. For this purpose, the steering wheel angle, the transverse acceleration, the wheel speeds and the combined signal determined with the aid of the yaw rate sensor arrangement are supplied to the Kalman filter as input variables. It should once again be emphasized at this point that an observer which is not designed as a Kalman filter can also be used as the observer.

As an alternative to the supply illustrated in FIG. 3 of the combined signal determined with the aid of the yaw rate sensor 1 to the Kalman filter 3 via the control apparatus 130, the combined signal can also be supplied directly from the yaw rate sensor 1 to the Kalman filter 3.

A method according to the invention according to a preferred illustrative embodiment is explained in greater detail below with reference to FIG. 3.

The yaw rate sensor 1 installed in an inclined position with a predetermined inclination angle a determines a combined signal, consisting of yaw rate and roll rate, and transmits this combined signal by means of the signal line 1a to the control apparatus 130. Furthermore, the control apparatus 130 receives the data measured by the individual wheel sensors 111 to 114 by means of the respective associated signal lines 111a to 114a.

Furthermore, additional sensors of the driving dynamics control system can be connected to the control apparatus 130 for additional state variables of the motor vehicle such as steering wheel angle, transverse acceleration or the like, for example. These sensors are combined into a block 140 in FIG. 3, from which the sensor signals determined are supplied to the control apparatus 130 via a signal line 140a.

As explained above, the sensor signal is split into the two components roll rate and yaw rate with the aid of the observer 3 designed as a Kalman filter. After such splitting, the control apparatus 130, in its function as analyzer arrangement, determines from the roll rate the associated roll angle, which is compared with threshold values stored in the storage arrangement 2. In the event of a predetermined threshold value being exceeded by the roll angle determined, the control apparatus 130, in its function as activation arrangement, can activate appropriate stabilization measures for stabilizing the vehicle. For this purpose, a corresponding signal is sent from the control apparatus 130 to the driving dynamics control system 150 via the signal line 150a, for example. This signal causes the driving dynamics control system to operate the brakes 121 to 124 via the associated signal lines 121a to 124a in an appropriate way for stabilizing the vehicle, for example for limiting the roll angle. With regard to the operation of the brakes 121 to 124, provision can alternatively be made for these also to be operated directly by the control apparatus 130. As a further stabilization measure, the control apparatus 130 can send a signal via a signal line 160a to a warning unit 160, which generates an optical and/or acoustic signal with which the driver is warned and at the same time advised to initiate appropriate braking activities.

The roll angle is obtained from the roll rate by integration. In this connection, the roll angle determined is checked for plausibility. This is effected by, for example, comparison of the roll angle with a maximum value for the roll angle determined by driving trials, for example. The roll angle determined must also be plausible in relation to the transverse acceleration detected.

Alternatively, additional lines from the control apparatus 130 to the correspondingly provided stabilization arrangements can be provided, which provide corresponding signals to the associated arrangements in the event of a predetermined threshold value being exceeded by the roll angle determined.

Advantageously, the driving dynamics control system already present is used and also taken into consideration for such roll angle limitation, and, additionally or alternatively, other roll angle limitation measures can be taken. For example, as described above, when a predetermined threshold value is exceeded by the roll angle determined, a warning signal can be issued by the control apparatus to the driver of the vehicle, who can then carry out appropriate stabilization of the motor vehicle by actuating the brakes.

Consequently, while falling back on the driving dynamics control system already provided in a motor vehicle, the present invention provides, by modified installation of the yaw rate sensor provided and corresponding evaluation modifications, a system and a method with which a critical state of the motor vehicle can be detected and appropriate intervention measures, for example brake action to stabilize tipping, are. activated. In this connection, it is possible by means of the state variables also determined by the driving dynamics control system to perform a plausibility check so that brake action takes place only in the case of actual critical states and the driving dynamics are not influenced in the case of non-critical states.

The transverse acceleration, the wheel speeds and the steering wheel angle, for example, can be evaluated for this plausibility check. This allows additional validation of the signal separation by means of the sensor technology, which is present in the vehicle anyway on account of the driving dynamics control system.

Although the present invention has been described above with reference to preferred illustrative embodiments, it is not limited to them but can be modified in various ways.

For example, the yaw rate sensor 1 can also be installed in the motor vehicle inclined with a predetermined inclination angle in the transverse direction, as a result of which a combined signal consisting of yaw rate and pitch rate is detected by the yaw rate sensor arrangement. Consequently, instead of the roll angle, the pitch angle can be determined, and appropriate stability measures can be activated in a similar way.

1. A device for determining the roll angle (φ) of a motor vehicle, in particular of buses, transporters, trucks or the like, with:
a yaw rate sensor arrangement (1) which is assigned to a driving dynamics control system and, for detecting a combined signal consisting of yaw rate and roll rate, is with its measuring axis inclined at a predetermined inclination angle (α) in relation to the vertical axis in the plane passing through the longitudinal axis and the vertical axis of the motor vehicle, and with
at least one observer (3), in particular a Kalman filter, which, for determining the roll angle (φ), splits the combined signal detected by the yaw rate sensor arrangement (1) into the two signal components yaw rate and roll rate.

2. The device as claimed in claim 1, characterized in that the yaw rate sensor arrangement (1) is mounted inclined in the direction of the motor vehicle front side with an inclination angle (α) of approximately 30°.

3. The device as claimed in 2, characterized in that the yaw rate sensor arrangement (1) is arranged approximately in the center of gravity (S) of the motor vehicle.

4. A system for roll stabilization of a motor vehicle, in particular of buses, transporters, trucks or the like, with:
a device for determining the roll angle (φ) of the motor vehicle, which is designed according to at least one of the preceding claims;
an analyzer arrangement (2, 130) for comparing the roll angle (φ) determined with a predetermined threshold value; and with
an activation arrangement (130), which activates an appropriate stabilization measure in the event of the predetermined threshold value being exceeded by the roll angle (φ) determined.

5. The system as claimed in claim 4, characterized in that the stabilization measure is designed as action on the brake system of the motor vehicle by the driving dynamics control system.

6. The system as claimed in claim 4, characterized in that the stabilization measure is designed as a warning signal to the driver, who can initiate appropriate braking activities.

7. The system as claimed in claim 4, characterized in that the analyzer arrangement is connected to the existing driving dynamics control system for taking state variables, for example the steering wheel angle, the transverse acceleration, the wheel speed, the yaw rate or the like, provided by the driving dynamics control system into consideration.

8. The system as claimed in claim 4, characterized in that the analyzer arrangement has a storage arrangement (2) for storing the predetermined threshold values.

9. A method for roll stabilization of a motor vehicle, in particular of buses, transporters, trucks or the like, with the following steps:
detecting a combined signal consisting of yaw rate and roll rate by means of a yaw rate sensor arrangement (1) which is assigned to a driving dynamics control system and is installed in the motor vehicle with its measuring axis inclined at a predetermined inclination angle (α) in relation to the vertical axis in the plane passing through the longitudinal axis and the vertical axis of the motor vehicle;
splitting the combined signal detected by the yaw rate sensor arrangement (1) into the two signal components yaw rate and roll rate by means of at least one observer (3), in particular a Kalman filter, for determining the roll angle (φ);
comparing the roll angle (φ) determined with a predetermined threshold value by means of an analyzer arrangement (2, 130), and
activating an appropriate stabilization measure by means of an activation arrangement (130) in the event of the predetermined threshold value being exceeded by the roll angle (φ) determined.

10. The method as claimed in claim 9, characterized in that the brake system of the motor vehicle is acted on by the driving dynamics control system as the stabilization measure.

11. The method as claimed in claim 10, characterized in that a warning signal is issued to the driver of the motor vehicle as the stabilization measure.

12. The method as claimed in claim 9 characterized in that the state variables, for example the steering wheel angle, the transverse acceleration, the wheel speeds, the yaw rate or the like, determined by the existing driving dynamics control system are also taken into consideration by the analyzer arrangement.

13. The method as claimed in claim 9, characterized in that the predetermined threshold values are stored in a storage arrangement (2).

14. The device as claimed in claim1, characterized in that the yaw rate sensor arrangement (1) is arranged approximately in the center of gravity (S) of the motor vehicle.

15. The method as claimed in claim 9, characterized in that a warning signal is issued to the driver of the motor vehicle as the stabilization measure.
